(19) United States
(12) Patent Application Publication
(10) Pub. No.: US 2014/0140066 A1
(43) Pub. Date: May 22, 2014

(54) LUMINAIRE HAVING LOW ECOLOGICAL IMPACT

(71) Applicant: Robert Dick, Ottawa (CA)

(72) Inventor: Robert Dick, Ottawa (CA)

(21) Appl. No.: 14/086,129

(22) Filed: Nov. 21, 2013

Related U.S. Application Data
(60) Provisional application No. 61/728,878, filed on Nov. 21, 2012.

(51) Int. Cl. F21V 15/01; F21K 99/00

(52) U.S. Cl. CPC F21V 15/011; F21K 9/00
USPC 362/294

(57) ABSTRACT

A light fixture that has low ecological impact is presented. Light is produced by Light Emitting Diodes (LEDs). The light spectrum is restricted to wavelengths that have low biological impact while providing fair colour recognition. The light is projected onto a target area to provide relatively uniform illumination to prevent over-bright regions. Glare and light trespass are limited by baffles and shielding, which is provided by the fixture housing and reflective optics. The adjustable light output can be selected after installation allowing a large range in mounting height for different applications. The light output can be programmed in the field to follow a user-defined daily schedule for turn on and turn off times, duration of illumination and illumination level. The heat sink-mounted LEDs are cooled by direct exposure to the ambient air.

### FIELD OF INVENTION

This invention relates to luminaires, and more particularly to luminaires for use in ecologically sensitive areas, and where the adverse biological impact of artificial light at night should be minimized, and where the adverse impact of artificial light at night on human health should be minimized.

### BACKGROUND

Although human vision has evolved to be optimum for daylight conditions, humans have sufficient vision during the night for pedestrian activity for which natural moonlight and starlight is sufficient. However the evolving urban lifestyles that include late night activity require higher levels of illumination than can be provided by natural sources. However, changing the natural night environment with artificial lighting fundamentally changes the ecology of the area.

The characteristics of artificial lighting have evolved over the past century. The following four characteristics impact human health and wildlife: spectrum, illumination level, glare and light trespass, and timing or scheduling of the light.

Studies from early in the 20^{th} century but primarily since 1999 have clearly identified the adverse impacts of these characteristics on wildlife and human health (Stephen Pauley (2004) Lighting for the Human Circadian Clock: Recent Research Indicates that Lighting has Become a Public Health Issue, Medical Hypotheses, 63, 588-596).

Extensive literature reviews have found that relatively low amounts of the four characteristics fundamentally changes the environment and alters biological processes and animal behaviours (C. Rich and T. Longcore, Editors, (2006) Ecological Consequences of Artificial Night Lighting, Island Press).

Short wavelength light reduces visibility due to Rayleigh scattering of light due to atmospheric particulates, and for humans, scratched automobile windshields, eyeglasses and imperfections in our eye lenses—especially in senior citizens. These combine to undermine visibility and safety.

Wildlife uses the illumination spectrum, illumination level and the timing of natural light to regulate their behaviour. Although humans consciously adapt their behaviour to artificial lighting, wildlife is oblivious to its artificial nature. This causes inappropriate behaviour when they are exposed to artificial lighting, leading to stress, predation and higher mortality. The four characteristics of artificial lighting set out in the earlier paragraph combine to undermine the subconscious reaction to light that provides human health and the survival of wildlife—exacerbating the survival of species at risk.

The light sources in current nighttime luminaires emit light from about 400 nm to over 650 nm. Light in the spectral band centered between 460-480 nm is subconsciously interpreted by our brain as indicating daytime. In response, the schedule for the nighttime release of hormones is altered, thus undermining the restorative benefits otherwise experienced at night.

The relatively high average illumination produced by luminaires, and their non-uniform light distribution, result in over-lighting in the centre of the illumination pattern and very low illumination in the periphery. This large range in illumination reduces visibility in the periphery. The bright illumination also bleaches our night vision cells (rod cells for scotopic vision) reducing our ability to see beyond the centre of the illumination pattern.

Relatively bright illumination constricts the iris and limits the light that enters the eye to that which passes through the centre of our lens. However, incipient cataracts begin to grow in the lenses of senior citizens. The incipient cataracts diffuse light, and thereby reduce the visual acuity of older people.

Although many current luminaires do not shine light above the horizon, the light that shines between 90 degrees and 80 degrees from nadir produces glare along roadways and pedestrian pathways. Glare from exposed lamps in luminaires further reduces our ability to see into the less-illuminated periphery.

Non-uniform illumination also increases the amount of electricity that is used, as higher wattage lamps are required to achieve the specified minimum illumination levels in the periphery.

High illumination levels that contain emissions in the blue part of the spectrum reduce the sensitivity the retinal cells that provides our scotopic (nighttime) vision. These cells are sensitive to light centred at 505 nm (from about 400 mm to 600 nm). Bright light in this range will “bleach” cells that require many minutes to recover. This spectrum also results in non-visual cells in our retina (intrinsically photosensitive Retinal Ganglion Cells, or ipRGCs) to miss-inform the brain that it is still daylight. This alters our restorative biochemistry that occurs at night and shifts timing of our circadian rhythm, and that of wildlife. This light also alters the behaviour of mammals, reptiles, insects, plant life and aquatic life.

A luminaire is needed that minimizes these visual, biological and behavioural effects by emitting only light with a spectrum greater than 500 nm, and that produces well-shielded and uniform illumination over the target area (Robert Dick (2013) Applied Scotobiology in Luminaire Design, Lighting Research and Technology, 0, 147).

LED luminaires have multiple interfaces through which heat must be conducted from the LED junction and ultimately rejected to the ambient air. The lifetime of a LED is sensitive to the temperature of the junction. Minimizing the number of interfaces, and particularly the surface-to-air interfaces, increases the lifetime of LEDs, and maximizing the heat transfer surface area also maximizes the lifetime of the LEDs.

Most current luminaires are designed for specific applications. Different luminaires are required for different situations. This results in large inventories to cover a range of uses.

A luminaire is needed that can be adjusted in the field by the user to suit their purpose. This will reduce the cost of maintaining a large inventory of different units.

Traffic density is used, in part, to determine the illumination level of urban and rural roadways. Traffic studies show that although the vehicle density is high during the morning and evening “rush-hours”, it is very low during the night. Most current outdoor luminaires maintain constant brightness throughout the night. And, most lamps cannot be dimmed on a schedule that follows the traffic density pattern. An illumination schedule that follows the predictable traffic patterns will significantly reduce electricity requirements for nighttime lighting.

A luminaire is needed that produces illumination that can be scheduled throughout the night as required by local circumstances. It should also use as little electricity as practical.

### SUMMARY

According to one aspect, a luminaire is provided that has low impact on the environment and the health of humans and wildlife. The luminaire comprises a light source, optics, shielding, an enclosure, and effective thermal management for the light source.

The invention is a luminaire with low environmental impact. It emits light over a limited range of wavelengths. The light is baffled and shielded to minimize light emitted beyond the target area and reduces glare and light trespass. In one embodiment of the invention, the luminaire has a controller that allows the user to set the desired illumination level for a range of mounting lights, schedule the operational characteristics: turn-on time, turn-off time and illumination level throughout the night. The user programs the controller with a portable programming device.

In this summary:

“Target area” refers to the area that is to be illuminated by the luminaire;

“Glare” refers to light that reduces our ability to see into areas of low illumination; and

“Light trespass” is that which shines outside the target area.

The emitted spectrum of the luminaire is greater than 500 nm to reduce its impact on the circadian rhythm by minimizing the stimulation of the intrinsically photosensitive Retinal Ganglion Cells (ipRGCs) in the retina that have a peak sensitivity between 450 and 500 nm.

The emitted spectrum minimizes the impact of the light on the scotopic rod cells of human vision, and that of animals, that have peak sensitivity at 505 nm.

The emitted light avoids the action spectrum of the plant photosensitive molecules chlorophyll (a and b), phytochrome (red and far red) and cryptochrome and thus reducing the impact of artificial light at night on the growth of plants.

The spectrum greater than 500 nm reduces the attraction of mosquitoes by the light.

Restricting the spectrum to greater than 500 nm minimizes the effects of Rayleigh scattering that is sensitive to short wavelength light. This reduces the impact of light scattering due to dust, fog, scratches on windows and eyeglasses, and imperfection in our eyes, thereby improving visibility in poor weather, when driving and for senior citizens.

The smooth variation in the spectral energy from 500 nm to over 650 nm results in a reasonably high colour rendering index (CRI) for the emitted light.

The illumination level can be set below the threshold limit of 3 lux to avoid the bleaching of the retina's rod cells in order to preserve dark adaptation of humans and animals. This limit is also the approximate threshold for the pupillary response. Therefore, the pupil will remain open to let more light into the eye than would otherwise occur at higher illumination levels.

With a large pupil, more light will enter the eye through the outer region of the lens. In the case of senior citizens, this prevents the situation where most of the light passes through the middle crystallized portion of the lens caused by incipient cataracts.

The luminaire of this invention has baffles that prevent the direct view of the LEDs. LEDs are relatively small light sources. In order to emit sufficient light for illumination they must be very bright. This intensity causes temporary blindness if viewed directly. Continued staring at the LEDs can cause more lasting damage.

The main mirror is a convex textured surface that reduces glare and small-scale structures in the illumination pattern. The main mirror diffuses the light from the LEDs to effectively dilute the light intensity over a large surface area without significantly reducing the total emitted light.

The main mirror reflects more light into the periphery of the target area to help produce a uniformity in illumination of 3:1. It has a hyperbolic surface with a shorter radius of curvature in the centre than at the edge. The curvature and tilt of the main mirror can be modified to expand or reduce the size of the target area.

The interior sides of the luminaire are specular mirrors. Their vertical angle is such that the reflected light contributes to the illumination uniformity in the target area that would otherwise cause light trespass and glare. The angle of these mirrors can be modified to expand or reduce the size of the target area.

The optics and the enclosure limit the light that is emitted between 90 degrees and 80 degrees from nadir to less than 1% of the total emitted light. This reduces the extent of low-level illumination beyond the target area. This minimizes the extent of the resulting impact on the biology and behaviour of animals.

The LEDs are mounted to the inside surface of an exterior wall, which is a finned heatsink. This arrangement provides only one surface-to-air interface with a maximum heat transfer area that extends over the face if the wall. This minimizes the temperature difference between the LED junction and the ambient air and results in the lowest possible LED temperature and long life for the LEDs.

In one embodiment, a controller manages the current to the LEDs. The user can program the controller with a portable programming device by inputting the time, date and location of the luminaire. The controller calculates the time of sunset and sunrise thereby avoiding the need for a daylight sensor and the required maintenance for the sensor.

The user may program the controller to adjust the amount of emitted light to maintain the specified illumination level for different mounting heights. The user may program the controller to schedule the time the luminaire is turned on and turned off with respect to sunrise and sunset, and to change the illumination level during the on-period. This minimizes the impact of the artificial lighting near the luminaire, and it reduces the amount of electricity used by the luminaire.

### BRIEF DESCRIPTION OF THE DRAWINGS

The features and advantages of embodiments of the invention will become more apparent from the following detailed description of the preferred embodiment(s) with reference to the attached figures, wherein:

FIG. 1A shows a profile view of a luminaire in section according to one embodiment of the invention;

FIG. 1B shows a side view of the luminaire in section according to one embodiment of the invention;

FIG. 1C shows a plan view of the luminaire in section according to one embodiment of the invention;

FIG. 2 shows an arrangement for mounting the LEDs of FIG. 1 onto the heat sink according to one embodiment of the invention;

FIG. 3 shows the sensitivity of a selection of various biochemical processes to light spectrum and attraction to mosquitoes;

FIG. 4 shows the emitted spectrum of the light emitting diodes of the luminaire according to one embodiment of the invention compared to the sensitivity of the photopic, scotopic and ipRGC cells in the human retina; and

FIG. 5 shows a block diagram of control of the luminaire according to one embodiment of the invention.

It is noted that in the attached figures, like features bear similar labels.

### DETAILED DESCRIPTION OF THE PREFERRED EMBODIMENTS

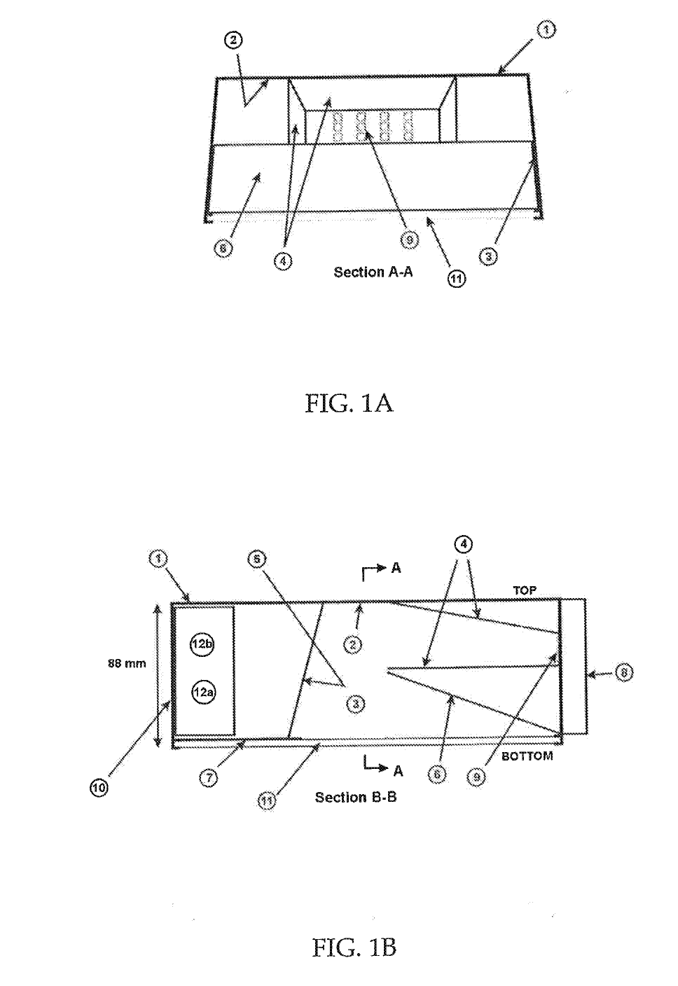

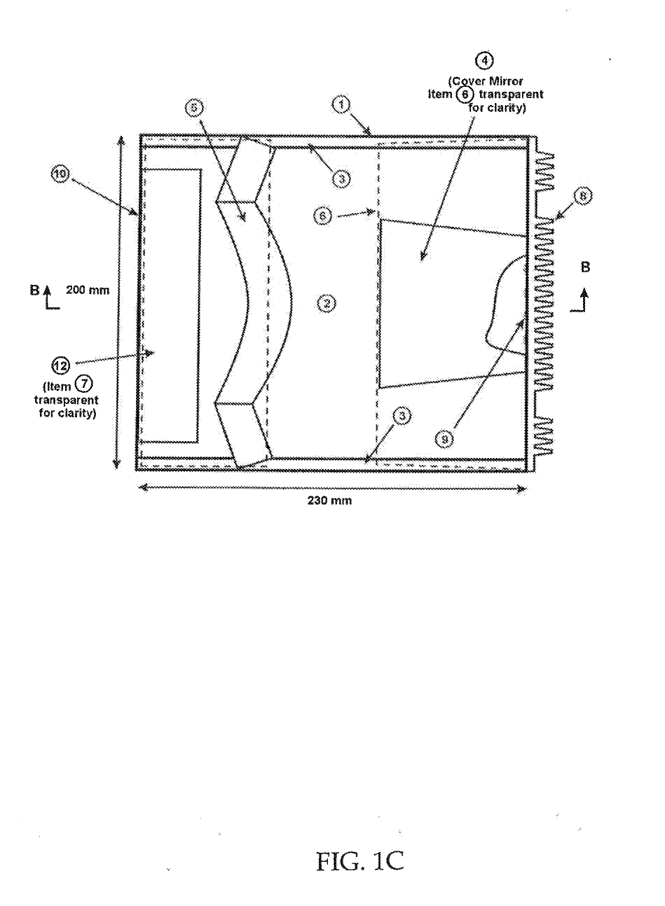

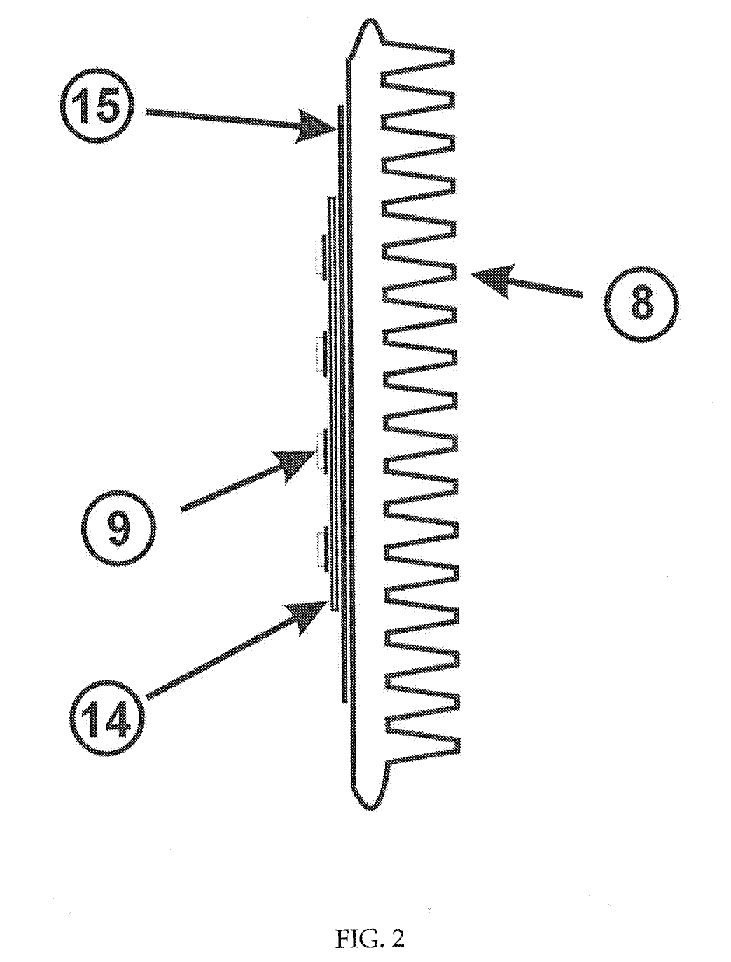

FIG. 1 shows the profile, side view and plan views of a luminaire in section according to one embodiment of the invention. An enclosure 1 forms three sides of the luminaire including the top and two angled walls. A floor mirror 2 covers the inside of the top of the enclosure and two side mirrors 3 cover the inside of the angled walls of the enclosure. A baffle assembly 4 prevents LEDs 9 from being seen, and the angled sides reflect the off-axis light towards a main mirror 5. A cover mirror 6 reduces the entrapped light in the luminaire. A window mirror 7 prevents light from shining behind the luminaire and reflects light down to the floor mirror 2 to illuminate the nadir below the luminaire.

A heat sink 8 is bolted to the enclosure 1 to form one wall of the luminaire. The LEDs 9 are mounted to the inside surface of the heat sink 8 with a thermally conductive dielectric adhesive layer. A window 10 resists in ingress of water and dust particles into the luminaire. It can be removed for cleaning and is kept in place by a metal cover plate.

A mounting plate 10 is bolted on to the opposite end of the enclosure 1 from the heat sink 8. It contains the user-specific mounting hardware for the luminaire. A controller and current driver 12 for the LEDs 9 are bolted to the mounting plate 10 on the inside of the luminaire. The LEDs 9 are driven by current from the current driver 12b. The emitted light has a spectrum that starts about 500 nm and smoothly increases with wavelength to a peak at about 600 nm. The amount of emitted light smoothly decreases from about 600 nm into the longer wavelengths. Less than 1% of the total emitted light is at wavelengths less than 500 nm and less than 15% of the total emitted light is at wavelengths longer than 650 nm.

FIG. 2 shows how the LEDs 9 are mounted on the heat sink according to one embodiment of the invention. The LEDs 9 are surface mounted to a copper circuit 14. This circuit is bonded to the heat sink 8 with a thin, thermally conductive dielectric adhesive layer 15. A large area of copper foil conducts heat laterally across the surface to maximize the area for thermal conductance, thereby reducing the thermal resistivity of the interface. The heat sink has a finned surface, which is exposed to the ambient air.

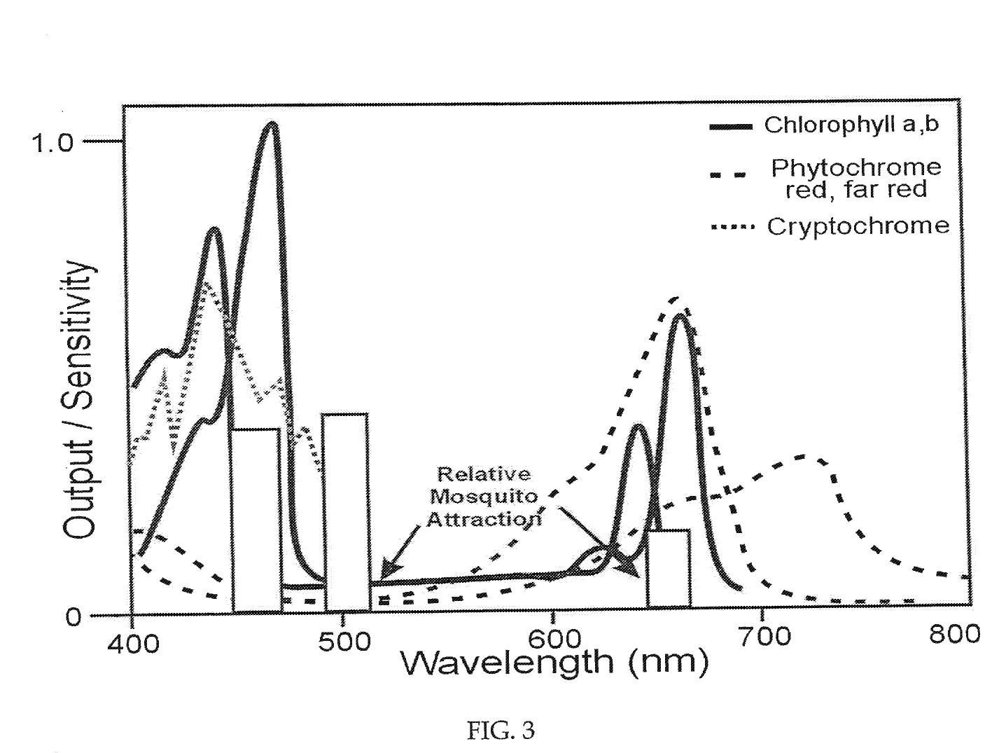

FIG. 3 shows a selection of action spectra for plant photo-molecules, and for the attraction of mosquitoes. Red light, approximately greater than 600 nm, affects photosynthesis (Chlorophyll a and b) and growth (phytochrome red and far red, PR and PFR respectively). These molecules are also sensitive to wavelengths shorter than 500 nm. However it has been reported in the peer reviewed literature that the cryptochrome mediates the light response (Nancy Eckardt (2003) A Component of the Cryptochrome Blue Light Signalling Pathway, The Plant Cell, Vol. 15, 1051). By minimizing the blue emitted light, the response to red light is reduced. The peer-reviewed literature identifies three spectra bands that attract mosquitoes. By avoiding blue light, this attraction is reduced.

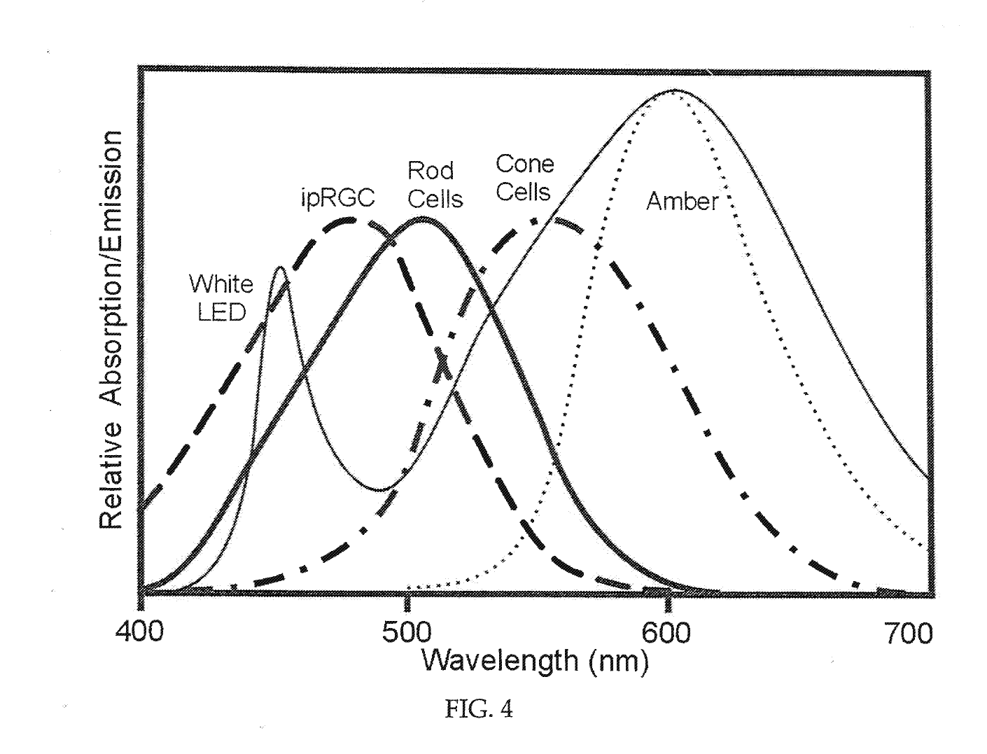

FIG. 4 shows the emitted spectrum of white and amber light emitting diodes compared to the sensitivity of our photopic, scotopic and ipRGC cells in our retina. The spectrum of white LEDs has a strong peak in the blue part of the spectrum and a broad band in the yellow to red wavelengths. The maximum sensitivity of the ipRGCs is less than 500 nm. The sensitivity of the scotopic vision cells (rod cells) peak at about 505 nm and the photopic vision (cone cells) peak at about 555 nm. The amber spectrum avoids the peak of the ipRGC and rod cells, while approximating the cone cell action spectrum. There is sufficient exposure to the sensitive rod cells to provide good visibility without bleaching the rod cells.

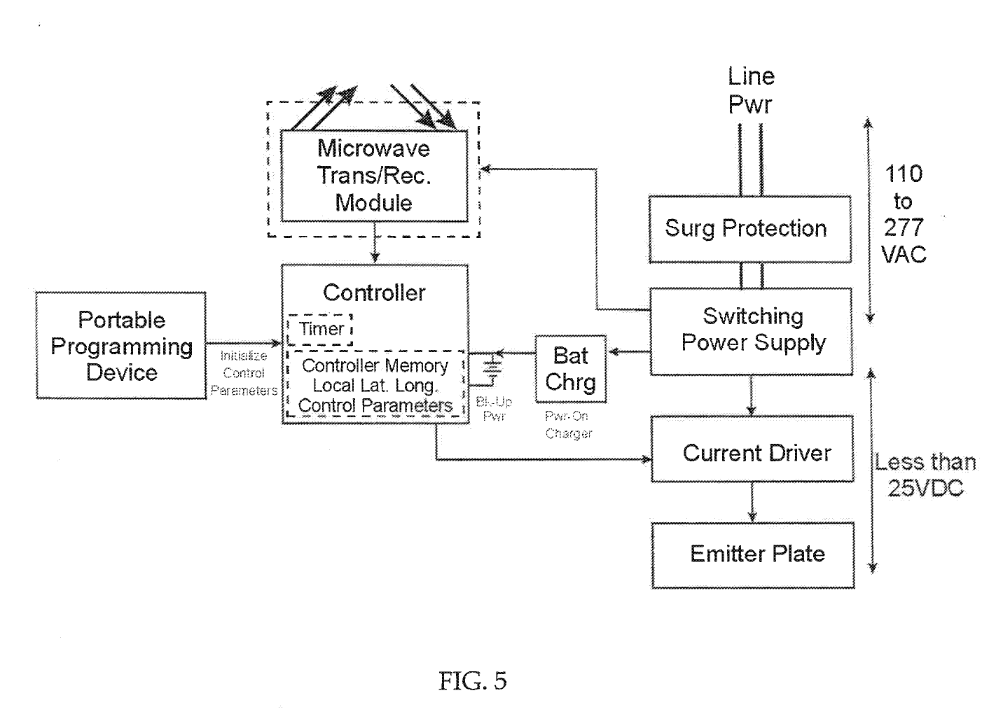

FIG. 5 shows the controller block diagram according to one embodiment of the invention. A surge protector filters line power to reduce the impact of spike voltages damaging the electronics. The line power is converted in a power supply to an intermediate DC voltage. A current source takes this power to drive the LEDs. The controller modulates the LED current to produce the required illumination to the programmed schedule by signaling the current driver.

A battery provides back-up power when the luminaire is disconnected or the power is off. The battery is recharged while the luminaire is on.

A user specifies the controller parameters and up-loads them to the controller memory from a portable programming device, either through a USB or wireless connection. This information includes time, date, latitude, longitude and altitude. These are used to calculate the local time of sunrise and sunset on which the illumination schedule is based. In one embodiment, a microwave transmitter/receiver detects a presence near the target area and turns on the luminaire if this function is enabled by the user. Alternatively, an infrared emitter/detector may be used instead of a microwave transmitter/receiver.

The invention has been described having optical characteristics, thermal regulation characteristics, and a controller. The thermal regulation characteristics and the controller each provide advantages to the luminaire but need not be present. Either, both, or neither the illustrated heat sink and controller could be present for the luminaire to still provide the optical benefits given by the arrangement of mirrors, the baffle assembly, and the LED characteristics.

The embodiments presented are exemplary only and persons skilled in the art would appreciate that variations to the embodiments described above may be made without departing from the spirit of the invention. The scope of the invention is solely defined by the appended claims.

I/We claim:

1. A luminaire that has low impact on the environment and the health of humans and wildlife comprising:
a light source;
optics;
shielding;
an enclosure; and
effective thermal management for the light source.

2. The luminaire of claim 1 wherein the light source is a set of light emitting diodes (LEDs).

3. The luminaire of claim 2 wherein the LEDs emit a spectrum in which at least 99% of the emitted light is greater than 500 nm.

4. The luminaire of claim 2 wherein the LEDs emit a spectrum that smoothly increases from 500 nm to about 600 nm and then slowly decreases into the far red part of the spectrum.

5. The luminaire of claim 2 wherein the LEDs emit less than 15% of their light at wavelengths greater than 650 nm.

6. The luminaire of claim 2 wherein the LEDs are mounted to the inside surface of an exterior wall.

7. The luminaire of claim 2 further comprising baffles that prevent a direct view of the LEDs.

8. The luminaire of claim 1 wherein the optics produce an illumination pattern with a uniformity of 1:3 over a target area.

9. The luminaire of claim 2 wherein the optics increase the apparent size of the LED light sources to greater than 20× the dimension of the LEDs.

10. The luminaire of claim 1 wherein the enclosure limits the emission of light from 80 degrees to 90 degrees from nadir to less than 1% of the total emitted light.

11. The luminaire of claim 1 further comprising a controller which schedules the timing and illumination level produced by the luminaire.

12. The luminaire of claim 11 wherein a user can program the controller.

13. The luminaire of claim 11 wherein the controller can be programmed with a portable programming device.
